(19) United States
(12) Patent Application Publication
(10) Pub. No.: US 2009/0136441 A1
(43) Pub. Date: May 28, 2009

(54) Method of fabricating nano-antifouling boat paint

(75) Inventors: Steve Lien-Chung Hsu, Tainan City (TW); Tsang-Tse Fang, Tainan City (TW); Hsing-I Hsiang, Tainan City (TW); Ming-Chung Fang, Tainan City (TW)

Correspondence Address: TROXELL LAW OFFICE PLLC, 5205 LEESBURG PIKE, SUITE 1404, FALLS CHURCH, VA, 22041, US

(73) Assignee: Fisheries Agency, Council of Agriculture, Executive Yuan, Taipei City (TW)

(21) Appl. No.: 11/896,734

(22) Filed: Sep. 5, 2007

(30) Foreign Application Priority Data
Jul. 12, 2007 (TW) 096125358

(51) Int. Cl. C09D 5/16

(52) U.S. Cl. 424/78.09

(57) ABSTRACT

A nano-scaled antifouling paint for boat is fabricated. A few hydrophobic nano-particles are added into the paint to obtain a nanostructure and a low surface energy. Thus, sea creatures are hard to adhere on the boat or are easily removed. Moreover, owing to a low wettability of the paint, a water drag is reduced when the boat sails, and so fuel is saved.

### FIELD OF THE INVENTION

The present invention relates to a boat paint; more particularly, relates to fabricating a nano-antifouling boat paint by adding a little hydrophobic nano-particles for avoiding sea creature adhesion and reducing drag.

### DESCRIPTION OF THE RELATED ARTS

After a period of time of use, a boat may be corroded by chloride ion, salt, liquid of different PH value and sea water of different temperature; and may be further adhered with sea creatures. No matter what material a boat is made of, wood, iron or fiberglass reinforced plastics (FRP), sea creatures can adhere on the boat to corrode or even ruin the boat. Hence, an anti-fouling system is very important to a boat.

A boat adhered with sea creatures may face the following problems:

(1) Boat surface may become rough to increase water drag to the boat and thus boat velocity is reduced with less mobility.

(2) The sea creatures adhered on the boat surface may add some weight to the boat, and, hence, more fuel may be used for sailing.

(3) More human resource may be needed to clean the boat regularly; hence, cost is increased and resources are wasted.

(4) Paint on the boat may be ruined and corroded with color faded.

Owing to sea creatures adhered on boat, a boat may have its weight increased and its velocity decreased. And the boat may use more fuel and exhaust more harmful gas. Thus, 40% more fuel may be required for a boat to sail with 77% more, weight added by the sea creatures adhered. Hence, there are some prior arts used to solve this problem.

A traditional antifouling paint is used for dealing with biofouling. The paint provides a toxicant, which mainly is tributyltin (TBT) or Cu₂O to gradually permeate to the sea in a certain way and velocity. The toxicant provides a certain density in the sea water around for killing sea creatures to prevent sea creature adhesion. Yet, permeability of the toxicant may be unsteady owing to different temperature and environment of the sea around, and the surface of the toxicant may be rough.

Another prior art is a tin-free self-polishing antifouling coating, whose product from a hydrolysis by the sea is a tin-free antifouling agent on a boat surface. However, it is functioned by sea water flow so that it may not obtain good effect if the boat velocity is too slow or the boat is harbored too long.

A third prior art is an organic composite of tributyltin (TBT) since 1960. The TBT is added in a paint to avoid sea creature adhesion. Yet, owing to the widely used TBT, sea environment is seriously endangered. It is because the TBT is lipid-soluble and will be gradually deposited on the seabed to contaminate sea creatures in the sea. Even more, the TBT may do big harm to human brain and placenta.

A fourth prior art is a copper-based antifouling paint since 1625. However, its toxicity is weaker than TBT for 1000 times. Additional toxicant is hence needed. Most commonly used toxicants can be ethylene bisdithiocarbamates (EBDC), including Zineb, Maneb and Mancozeb. These toxicants are not stable and may produce ethylene thiourea (ETU), which is confirmed to be able to cause thyroid tumors to rat.

To sum up, sea creatures may adhere on any object of a boat, like sonar, torpedo tube, sea water cool system of nuclear power plant, etc. The sea creatures adhered on the boat makes the boat velocity reduced, the fuel consumption increased and the operation cost heightened. Yet the above prior arts either are too weak in their toxicity or may do harm to the environment; and so they can not solve the problem of the sea creature adhesion well. Hence, the prior arts do not fulfill all users' requests on actual use.

### SUMMARY OF THE INVENTION

The main purpose of the present invention is to avoid sea creature adhesion and reduce drag by adding a few hydrophobic nano-particles with a reduced cost.

To achieve the above purpose, the present invention is a method of fabricating a nano-antifouling boat paint, comprising steps of: a) forming a copolymer membrane of an adhesive composition; b) adding nano-particles with fluoroalkylsilane modification in the copolymer membrane; c) adding an antifoulant having a copper composite into the copolymer membrane to obtain a nano-antifouling boat paint; and d) processing a physical-state test, a biological-toxicity test, a drag-reducing ability test and an antifouling test of boat to the nano-antifouling boat paint to confirm efficiencies of the nano-antifouling boat paint on avoiding sea creature adhesion and on reducing drag. Accordingly, a novel method of fabricating a nano-antifouling boat paint is obtained.

### BRIEF DESCRIPTION OF THE DRAWING

The present invention will be better understood from the following detailed description of the preferred embodiment according to the present invention, taken in conjunction with the accompanying drawing, in which

FIG. 1 is the flow view showing the preferred embodiment according to the present invention.

### DESCRIPTION OF THE PREFERRED EMBODIMENT

The following description of the preferred embodiment is provided to understand the features and the structures of the present invention.

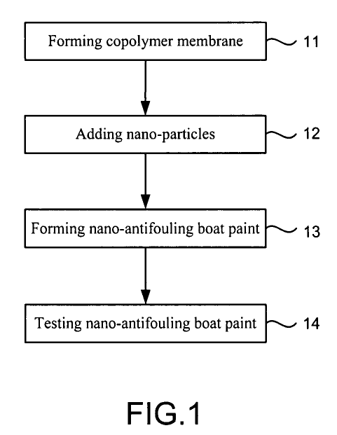

Please refer to FIG. 1, which is a flow view showing a preferred embodiment according to the present invention. As shown in the FIGURE, the present invention is a method of fabricating a nano-antifouling boat paint, comprising the following steps:

(a) Forming a copolymer membrane 11: A copolymer membrane is formed with an adhesive composition, where the copolymer membrane comprises more than one silicone monomer, oligomer and polymer to be copolymerized; or comprises more than one vinyl unsaturated monomer, oligomer and polymer to be copolymerized.

(b) Adding nano-particles 12: Nano-particles with fluoroalkylsilane modification are added into the copolymer membrane with a weight percents (wt %) between 0.5 and 50, where the nano-particle has a granular diameter between 5 and 100 nanometers (nm); and the nano-particle is a metal, oxide, sulfide, nitride, carbide or polymer nano-particle.

(c) Forming a nano-antifouling boat paint 13: A 0˜30 wt % antifoulant having a copper composite is further added to the copolymer membrane to form a nano-antifouling boat paint, where the copper composite is cuprous oxide (Cu₂O).

(d) Testing the nano-antifouling boat paint 14: A physical-state test, a biological-toxicity test, a drag-reducing ability test and an antifouling test of boat are processed to the nano-antifouling boat paint to confirm efficiencies of the nano-antifouling boat paint on avoiding sea creature adhesion and on reducing drag.

On using the present invention, a surface of the nano-antifouling boat paint obtains a nanostructure and a low surface energy by adding the nano-particles treated with a hydrophobic treatment so that sea creatures are hard to be adhered or are slightly adhered on the boat. However, even when some sea creatures are adhered, they have a very weak adhesive interface over the nano-antifouling boat paint. So, when the boat is sailing on the sea, the sea creatures are easily removed with an impulsive force and a shear stress of water to the nano-antifouling boat paint on a shell of the boat.

Concerning the physical-state test of the nano-antifouling boat paint, a contact angle between 140 and 150 degrees is obtained, which shows a very small surface tension; a hardness about 4H is obtained, which is about the same as a common antifouling boat paint; and an adhesion between 2.1 and 2.5 Mpa is obtained, which is also about the same as a common antifouling boat paint. Together with all the above physical states, the nano-antifouling boat paint has advantages of a low surface energy, a high hardness and a good adhesion. After a salt solution spray test for 12, 24, 36, 48, 60 and 72 hours, the hardness still remains. When it is exposed in the sea, only few sea creatures are adhered and the sea creatures can be easily removed through a circulating water tank.

Concerning the biological toxicity test, the nano-antifouling boat paint has no harm to the environment even a little cuprous oxide is added.

Concerning the drag-reducing ability test, a flange resistance obtains a drag reduction for 11.5% when a boat velocity is between 2.24 and 8.98 knots; and a ship mould resistance obtains a drag reduction for 13.8% when a boat velocity is between 1.56 and 6.25 knots. With all the above drag reduction, a boat having a middle or low velocity obtains a fuel reduction about 10 to 12 percents by using the nano-antifouling boat paint.

Concerning the antifouling test of boat, the nano-antifouling boat paint is not adhered with sea creatures obviously, which shows that the nano-antifouling boat paint avoids adhesion of sea creatures with characteristics of nano-scaled non-toxicity and hydrophobicity.

Thus, the nano-antifouling boat paint obtained according to the present invention is added with only a few nano-particles to reduce cost and avoid sea creature adhesion. And so the boat does not need to go into dock often for cleansing and thus human labor and money are saved. In addition, the nano-antifouling boat paint had a reduced wettability to water so that a drag reduction to water is increased and thus fuel is saved.

To sum up, the present invention is a method of fabricating a nano-antifouling boat paint, where a cost is saved, sea creature adhesion is avoided and a drag is reduced by adding only a few hydrophobic nano-particles to an antifouling boat paint.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a nano-antifouling boat paint, comprising steps of:
(a) obtaining a copolymer membrane of an adhesive composition;
(b) adding nano-particles with fluoroalkylsilane modification in said copolymer membrane;
(c) adding an antifoulant having a copper composite into said copolymer membrane to obtain a nano-antifouling boat paint; and
(d) processing a physical-state test, a biological-toxicity test, a drag-reducing ability test and an antifouling test of boat to said nano-antifouling boat paint.

2. The method according to claim 1,
wherein said copolymer membrane comprises more than one silicone monomer, oligomer and polymer to be copolymerized.

3. The method according to claim 1,
wherein said copolymer membrane comprises more than one vinyl unsaturated monomer, oligomer and polymer to be copolymerized.

4. The method according to claim 1,
wherein said nano-antifouling boat paint has nano-particles whose granular diameters are between 5 and 100 nanometers.

5. The method according to claim 4,
wherein said nano-particle is selected from a group consisting of a metal nano-particle, an oxide nano-particle, a sulfide nano-particle, a nitride nano-particle, a carbide nano-particle and a polymer nano-particle.

6. The method according to claim 1,
wherein said nano-particles with fluoroalkylsilane modification have a 0.5 to 50 weight percents (wt %).

7. The method according to claim 1,
wherein said antifoulant has a 0 to 30 weight percents.

8. The method according to claim 1,
wherein said copper composite is cuprous oxide (Cu₂O).
